(19) United States
(12) Patent Application Publication
(10) Pub. No.: US 2007/0295367 A1
(43) Pub. Date: Dec. 27, 2007

(54) Apparatus and Method For Wet Treatment of Wafers

(75) Inventor: Harald Okorn-Schmidt, Klagenfurt (AT)

Correspondence Address: YOUNG & THOMPSON, 745 SOUTH 23RD STREET, 2ND FLOOR, ARLINGTON, VA, 22202, US

(73) Assignee: SEZ AG, Villach (AT)

(21) Appl. No.: 11/667,698

(22) PCT Filed: Nov. 15, 2005
(86) PCT No.: PCT/EP05/55979

§ 371 Date: May 14, 2007

(30) Foreign Application Priority Data
Nov. 23, 2004 (AT) A 1968/2004

(51) Int. Cl. B08B 1/02; B08B 3/00

(52) U.S. Cl. 134/32; 134/137

(57) ABSTRACT

Disclosed is a device for wet treatment of disk-like substrates comprising a first plate (10) with a size and shape being able to overlap a disk-like substrate to be treated, holding means (22) for holding a disk-like substrate (W) parallel to said first plate in a s distance of 0.2 to 5 mm, rotating means (37) for rotating the disk-like substrate (W) about a rotation axis (A) substantially perpendicular to said first plate, first dispensing means (14) with a first dispensing opening (16) in the first gap for introducing fluid into a first gap (11) between said first plate (10) and a disk-like substrate (W) when being treated, and shifting means (34) for shifting the position of said first dispensing opening (16) from a first position (P1) to a second position (P2) wherein the distance of said first position (P1) to the rotation axis (A) is smaller than the distance of said second position (P2) to the rotation axis (A). Furthermore an associated method is disclosed.

The invention relates to a device for wet treatment of disk-like substrates comprising a first plate with a size and shape being able to overlap a disk-like substrate to be treated holding means for holding a disk-like substrate parallel to said first plate in a distance of 0.2 to 5 mm rotating means for rotating the disk-like substrate about a rotation axis substantially perpendicular to said first plate. First dispensing means are provided for introducing fluid into a first gap between said first plate and a disk-like substrate when being treated. If in the following the term wafer is used such disk-like substrates are meant.

Such a device will mainly be used to clean particles off the wafer surface but can also be used to clean contamination of ionic or organic nature. After the cleaning step various etching and passivation steps may be carried out.

U.S. Pat. No. 4,401,131 A1 discloses a wafer-cleaning device, wherein the wafer is held by a vacuum spin chuck 25 and rotated. Simultaneously cleaning liquid is supplied between the wafer and the transducer-plate through a central opening in the transducer plate.

U.S. Pat. No. 5,979,475 A1 discloses a wafer-cleaning device comprising two parallel plates optionally having an ultrasonic vibrator for treating both sides of a wafer sandwiched there between. The wafer floats on liquid cushions generated by liquid introduced through central openings of each plate. The wafer is not held by any further element and is therefore allowed to rotate freely.

Both devices have the disadvantage that the centre of the wafer may be poorly cleaned because it is hardly agitated by ultrasonic (if used) due to shielding through the fluid inlet, and the liquid does not flow across the wafer parallel to the wafer surface. Flowing across the wafer is helpful to transport loosened particles away from the wafer surface no matter whether ultrasonic is used or not.

Therefore investigations have been made with an eccentric liquid supply. Such eccentric liquid supply however leads to the disadvantage that it might happen that liquid introduced to the dry gap does not properly wet the centre of the wafer or the drying of the wafer might become a problem due to non-radial conditions.

It is an object of the invention to simultaneously solve the problems of wetting the centre of the wafer and properly cleaning the centre of the wafer.

Other objects of the invention are to further enhance cleaning uniformity and cleaning efficiency.

The invention meets the objects by providing a device for wet treatment of disk-like substrates comprising
a first plate with a size and shape being able to overlap a disk-like substrate to be treated
holding means for holding a disk-like substrate parallel to said first plate in a distance somewhere in the range of 0.2 to 5 mm
rotating means for rotating the disk-like substrate about a rotation axis substantially perpendicular to said first plate
first dispensing means with a first dispensing opening in the first gap for introducing fluid into a first gap between said first plate and a disk-like substrate when being treated
shifting means for shifting the position of said first dispensing opening with respect to the rotation axis from a first position to a second position wherein the distance of said first position to the rotation axis is smaller than the distance of said second position to the rotation axis.

A plate may have the shape of any kind of body, which has a flat surface serving as a plate. Such bodies may be a cone, a frustum, a cylinder, a circular disk or similar. The plate may be made of polymer material such as poly tetra fluor ethylene (e.g. Teflon™), metal with coated surfaces or any other material inert to the treating fluids used or with an appropriate coating.

The dispensing opening may comprise one dispense nozzle or a plurality of dispense nozzles, which may be arranged parallel or coaxial.

It is advantageous if said first dispensing opening when being in said first position includes the rotation axis whereas it does not include said rotation axis in said second position.

The current invention brings the advantage that within one and the same device liquid can be introduced selectively either in the centre or off the centre of a rotational movement of a disk-like substrate when being treated. For instance it may be advantageous on the one hand to clean a disk-like substrate when liquid flows across the central area of a disk-like substrate without being disturbed by any element such as a dispensing opening. On the other hand it may be useful to dry the disk-like substrate thereafter by introducing drying gas to the rotation centre of the disk like substrate.

Preferably said shifting means are for changing the distance d of said first dispensing opening to the rotation axis from d1 to d2, wherein d1 is in the range of 0 to 1 mm and d2 is in the range of 3 to 20 mm. Such shifting means comprises driving elements such as a belt drive, gear drive, pneumatic cylinder or ball spindle. The shifting means may either shift said first plate or may shift the rotatable holding means i.e. the rotation axis may be shifted.

A device according to another embodiment further comprises a second plate substantially parallel to said first plate so that a chamber is provided by the two plates in order to receive a disk-like substrate to be treated therein.

Advantageously the device further comprises second dispensing means for introducing fluid into a second gap between said second plate and a disk-like substrate when being treated. Such fluid may be gas or liquid. The second dispensing means and the size of the second gap is configured so that the second dispensing means, when delivering liquid, are able to completely fill the second gap with such liquid.

Furthermore the device may comprise at least one vibrating element acoustically coupled to at least said first plate. The at least one vibrating element may be a piezoelectric transducer. Such piezoelectric transducers shall be bonded to a reasonable resonator typically made of rigid material like quartz, stainless steel, aluminum, glass or sapphire, SiC or BN. For bonding a transducer to the resonator a rigid medium such as glass or quartz may be used. If the plate's material is not a rigid material the resonator could be coupled to the plate through an intermediate medium like water.

Advantageously said holding means and said second plate are coupled to each other to form a rotatable holding unit (a spin chuck).

A second aspect of the invention is a method for wet treatment of a disk-like substrate comprising
placing a disk-like substrate to be treated parallel to a first plate in a distance somewhere in the range of 0.2 to 5 mm
rotating the disk-like substrate about a rotation axis substantially perpendicular to said first plate
inserting a first liquid through a first dispensing opening into said first gap thereby substantially completely filling said first gap
shifting the position of said first dispensing opening with respect to the rotation axis from a first position to a second position wherein the distance of said first position to the rotation axis is smaller than the distance of said second position to the rotation axis.

Advantageously said first dispensing opening when being in said first position includes the rotation axis whereas it does not include said rotation axis in said second position. The first position can be used for filing liquid into the first gap, rinsing and drying the disk-like substrate. The second position may be used when cleaning liquid is applied e.g. during ultrasonic treatment.

It is useful if one treatment step is carried out when said first dispensing opening is at the first position and another treatment step is carried out when said first dispensing opening is at the second position.

Advantageously a first treatment step is carried out when said first dispensing opening is at the first position and a subsequent treatment step is carried out when said first dispensing opening is at the second position.

In one embodiment of the method ultrasonic energy is applied to the disk-like substrate during at least a time sequence during the disk-like substrate treatment.

Preferably at least part of the time, during applying ultrasonic energy, the first dispense opening is set off the rotation axis, which means that the dispense opening does not include the rotation axis.

For uniformity purposes it might be useful to shift the position of said first dispensing opening with respect to the rotation axis during at least a time sequence when ultrasonic energy is applied to the substrate.

This can be done periodically with a given frequency (shifting frequency). It is preferred if such frequency is not an integer multiple of the used rotation frequency or if the shifting frequency is selected at least 5 times smaller than the rotation frequency (e.g. rotation frequency=60 min⁻¹; shifting frequency=7 min⁻¹).

Further details of the invention will become apparent from the following drawings and the detailed description referring thereto.

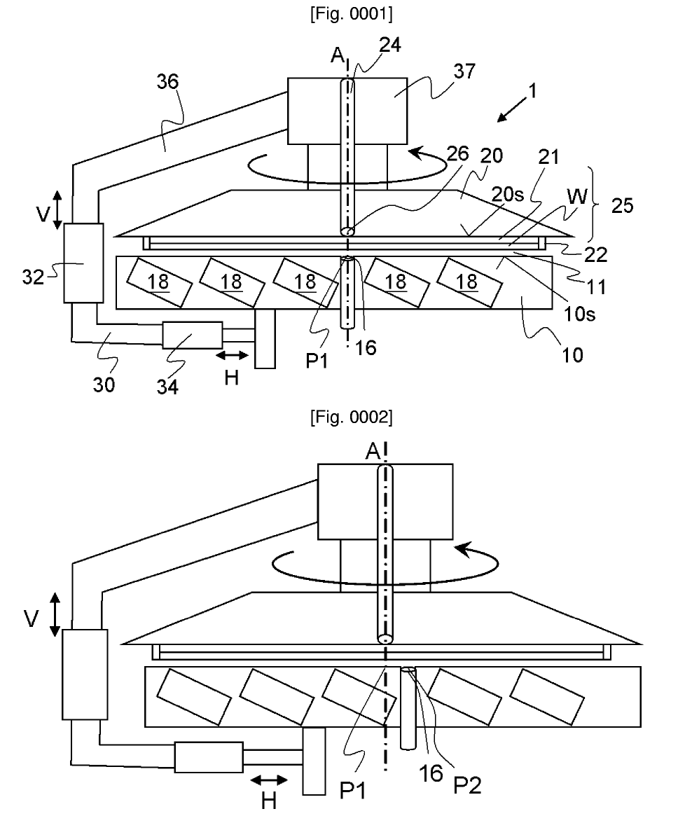

FIG. 1 shows a schematic drawing of a device 1 according to one embodiment of the invention.

A spin chuck 25 for rotatable holding a wafer W is mounted in a hanging position in order to hold the wafer W below it. Spin chuck 25 comprises gripping pins 22 for securely holding the wafer W at the wafer's edge. The gripping pins can be either eccentrically moved or tilted for gripping and releasing the wafer W. The mechanism (not shown) for moving gripping pins can be similar to the mechanism disclosed in U.S. Pat. No. 4,903,717. The spin chuck 25 further comprises a chuck plate 20 with a plane surface 20s parallel to a wafer when being treated and covering the wafer. The plane 20s has a dispensing opening 26 in its centre for receiving a fluid nozzle. The spin chuck 25 is mounted by a coaxial hollow shaft to a hollow shaft motor 37. The rotation axis A of shaft and spin chuck 25, about which the spin chuck 25 is rotated, is perpendicular to the plane surface 20. Within the hollow shaft a tube 24 is inserted coaxially. The tube is welded to the plane 20s at its central dispensing opening. The tube may either serve as housing for different fluid pipes (e.g. for liquid and/or gas) or may serve as fluid pipe itself. For connecting tube 24 to a tubing system a rotating union (not shown) is used.

A lower plate 10 is arranged below the spin chuck 25. The lower plate 10 has a plane surface 10s facing the spin chuck 25 and being substantially parallel to the plane surface 20s of the spin chuck 25. In other words parallel planes 10s and 20s form a chamber, which is circumferential open to ambient. The space between the two planes is provided for the wafer to be treated. The wafer then will be sandwiched between planes 10s and 20s. A borehole 14 in the lower plate 10 opens in a central dispense opening 16 being located in the plane 10s. The borehole 14 may either serve as housing for different fluid pipes (e.g. for liquid and/or gas) or may serve as fluid pipe itself. A plurality of ultrasonic transducers is glued to the lower plate 10, which then serves as a resonator plate. Through lower plate 10 ultrasonic energy is then transmitted from transducers to the medium and further more to the wafer surface.

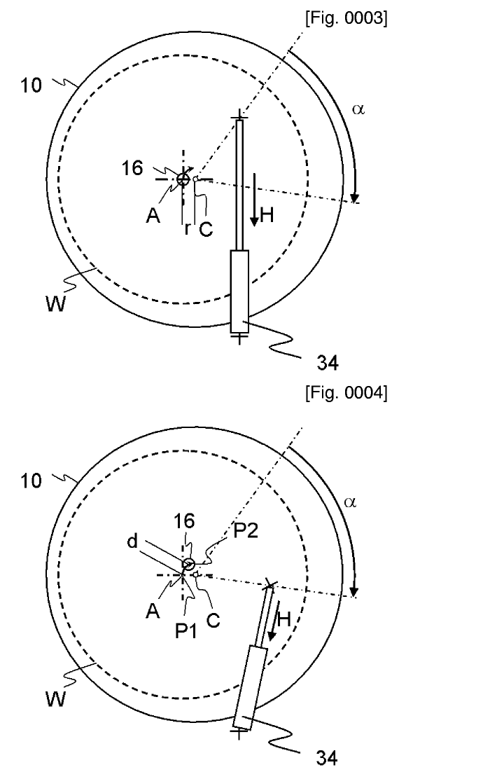

The bearing of lower plate 10 is arranged so that lower plate 10 can be moved substantially parallel to the plane 10s. Such movement can either be a linear movement or a turning about a centre, which is eccentric with respect to the rotation axis A (further described with reference to FIG. 3 and FIG. 4). The purpose of this movement (illustrated by arrow H) is to shift the dispense opening 16 from a first position P1, where axis A goes through the dispense opening 16, to a second position P2 (FIG. 2), where the dispense opening is set off the rotation axis A. The movement is carried out by a linear motor 34 (e.g. a pneumatic cylinder).

Lower plate 10 is connected to the spin chuck 25 via frame elements 30 and 36. In order to change the distance between wafer W and the lower plate 10 a lifting motor 34 lifts the spin chuck 25.

The lower plate 10 is circumferentially surrounded by an annular liquid collector (not shown), which may also be called cup, bowl or splashguard respectively. The lower plate 10 is sealed against the liquid collector with an O-ring seal (not shown) or the lower plate 10 is part of the liquid collector or welded thereto. The liquid collector comprises an annular duct for collecting liquid, which is flung of the wafer during wet treatment and the liquid is drained through an opening near the bottom of the annular duct. The liquid collector further comprises an annular gas suction nozzle directed inwardly above the annular duct for receiving ambient gas and mist deriving from wet treatment. The inner diameter of the upper part of the liquid collector 10 is larger than the outer diameter of the spin chuck 25 so that the first plate can be inserted into the liquid collector leaving a circumferential gap of 0.2-5.0 mm. The gap shall be small enough to seal the wafer against the ambient during treatment but big enough to avoid friction between the spin chuck 25 and the liquid collector during the spin chuck 25 being rotated. Furthermore the liquid collector shall allow the horizontal shift H without colliding with the spin chuck 25.

Following a cleaning method according to one embodiment of the invention is described with reference to the above-described device shown in FIG. 1 and FIG. 2.

A semiconductor wafer shall be cleaned during integrated circuit manufacturing.

The device is opened by lifting (V) the spin chuck 25 from the lower plate 10 to open so that the gap between the plate of the spin chuck 25 and the lower plate has a distance of 20 mm. The gripping pins 22 are opened and the wafer is entered into the device. Thereafter the gripping pins 22 are closed to securely hold the wafer and the spin chuck 25 is lowered to bring wafer W in close proximity to the lower plate 10. The device side of the wafer, which carries the integrated circuits faces the lower plate 10. The distance of the wafer surface, which faces the lower plate, to the upper surface 10s of the lower plate is preferably selected as 1 mm. The lower plate 10 is in a position so that the dispense opening 16 of the lower plate incorporates the rotation axis A of the spin chuck 25. In other words the dispense opening 16 of the lower plate 10 is substantially in the centre with respect of the rotational movement of the spin chuck 25. A cleaning fluid (e.g. SC2, a mixture of water, hydrogen peroxide, hydrochloric acid), which is entered through the dispense opening 16, fills the lower gap 11 completely and thereby wets the lower wafer surface as well as the surface 10s of the lower plate 10. Simultaneously the upper gap 21 between the wafer and the plate 20 of the spin chuck 25 is filled through dispense opening 26.

When both gaps 11, 21 are filled the lower plate 10 is horizontally shifted by 15 mm (H) and the centre of the dispense opening 16 is moved to position P2 (FIG. 2). Thereafter transducers 18 are switched on (1500 kHz) and the spin chuck 25 is rotated at a spin speed of 20 rpm. Meanwhile volume flows of liquids through dispense openings 16 and 26 are kept constant each at 0.1 litre by minute. Liquid flowing through lower gap 11 and upper gap 21 together flow into the liquid collector and are drained or recycled.

As the dispense opening 16 is now set off the rotational centre P1 ultrasonic energy is uniformly transmitted even to the centre of the wafer because the centre is covered by the resonator plate 10.

After ultrasonic cleaning step (ultrasonic transducers are switched off) the lower plate 10 is shifted back so that rotational axis again goes through dispense opening 16 (position P1). Cleaning liquid on both wafer sides may thereafter either be displaced by gas or liquid. If gas is used for instance it can be nitrogen, 2-propanol vapour, water vapour or a mixture thereof. A mixture of nitrogen and 2-propanol vapour is preferred. Displacing cleaning liquid with gas brings the advantage that the cleaning liquid can be recycled without any significant loss. Thereafter both wafer sides are rinsed with deionized water (DI-water).

If cleaning liquid is directly displaced by a rinsing liquid (such as DI-water), intermediate liquid, which is a mixture of cleaning liquid and rinsing liquid, cannot be recycled and thus has to be run into drain.

No matter whether cleaning liquid is directly displaced with rinsing liquid or with gas the rinsing liquid is displaced by drying gas (e.g. dry air, nitrogen, 2-propanol vapour or a mixture thereof). During applying drying gas spin chuck 25 may accelerated up to 100 rpm in order to further enhance drying efficiency.

After drying the device 1 is opened again and the wafer is picked from the spin chuck 25.

FIG. 3 and FIG. 4 show schematic views from below of an alternative mechanism for shifting the position of said dispensing opening 16 from a first position P1 to a second position P2.

The lower plate 10 is circle shaped, rotatable mounted concentric with the surrounding collector and sealed against said collector. The dispense opening 16 is located eccentric to the centre C of the lower plate 10 but in the rotational centre of the spin chuck which rotates about axis A. W indicates the wafer. When the lower plate 10 is turned about its rotational centre C by an angle α the dispense opening moves from the first position P1 to a second position P2. The turning is driven by pneumatic cylinder 34. The distance d from P1 to P2 is depending on angle α and offset r of P1 to the rotational centre C of the lower plate 10 and follows the equation 1.
d=2r sin α/2 (equ. 1)

If r is 15 mm and α is 50° d will be about 13 mm.

1. Device for wet treatment of disk-like substrates comprising
a first plate (10) with a size and shape being able to overlap a disk-like substrate to be treated
holding means (22) for holding a disk-like substrate (W) parallel to said first plate in a distance of 0.2 to 5 mm
rotating means (37) for rotating the disk-like substrate (W) about a rotation axis (A) substantially perpendicular to said first plate
first dispensing means (14) with a first dispensing opening (16) in the first gap for introducing fluid into a first gap (11) between said first plate (10) and a disk-like substrate (W) when being treated
shifting means (34) for shifting the position of said first dispensing opening (16) with respect to the rotation axis (A) from a first position (P1) to a second position (P2) wherein the distance of said first position (P1) to the rotation axis (A) is smaller than the distance of said second position (P2) to the rotation axis (A).

2. Device according to claim 1 wherein said first dispensing opening (16) when being in said first position (P1) includes the rotation axis whereas it does not include said rotation axis (A) in said second position (P2).

3. Device according to claim 1 further comprising a second plate (20) substantially parallel to said first plate (10) so that a chamber is provided by the two plates in order to receive a disk-like substrate to be treated therein.

4. Device according to claim 2 further comprising second dispensing means (24) for introducing fluid into a second gap between said second plate and a disk-like substrate when being treated.

5. Device according to claim 2 further comprising at least one vibrating element (18) acoustically coupled to at least said first plate (10).

6. Device according to claim 2 wherein said holding means (22) and said second plate (20) are coupled to each other to form a rotatable holding unit.

7. Method for wet treatment of a disk-like substrate
placing a disk-like substrate to be treated parallel to a first plate in a distance of 0.2 to 5 mm
rotating the disk-like substrate (W) about a rotation axis (A) substantially perpendicular to said first plate
inserting a first liquid through a first dispensing opening (16) into said first gap thereby substantially completely filling said first gap
shifting the position of said first dispensing opening (16) with respect to the rotation axis (A) from a first position (P1) to a second position (P2) wherein the distance of said first position (P1) to the rotation axis (A) is smaller than the distance of said second position (P2) to the rotation axis (A).

8. Method according to claim 7 wherein said first dispensing opening (16) when being in said first position (P1) includes the rotation axis whereas it does not include said rotation axis (A) in said second position (P2).

9. Method according to claim 7 wherein one treatment step is carried out when said first dispensing opening is at the first position (P1) and another treatment step is carried out when said first dispensing opening is at the second position (P2).

10. Method according to claim 7 wherein a first treatment step is carried out when said first dispensing opening is at the first position (P1) and a subsequent treatment step is carried out when said first dispensing opening is at the second position (P2).

11. Method according to claim 7 wherein ultrasonic energy is applied to the disk-like substrate during at least a time sequence during the disk-like substrate treatment.

12. Method according to claim 11 wherein the position of said first dispensing opening (16) is shifted with respect to the rotation axis (A) during at least a time sequence when ultrasonic energy is applied to the substrate.
